(19) United States
(12) Patent Application Publication
(10) Pub. No.: US 2011/0224891 A1
(43) Pub. Date: Sep. 15, 2011

(54) METHOD AND APPARATUS FOR AGGREGATING TRAFFIC INFORMATION USING RICH TRIP LINES

(75) Inventor: Tochukwu IWUCHUKWU, Mountain View, CA (US)

(73) Assignee: Nokia Corporation, Espoo (FI)

(21) Appl. No.: 12/721,079

(22) Filed: Mar. 10, 2010

(51) Int. Cl. G08G 1/00

(52) U.S. Cl. 701/117

(57) ABSTRACT

Techniques to aggregate traffic information with rich trip lines include a traffic service that, in response to receiving data indicating a current position, determines an ordered plurality of trip lines that indicate positions where a traffic condition is to be reported, and returns data that indicates the ordered trip lines. The trip lines are ordered such that a traveler encountering two trip lines of the plurality of trip lines in a different sequence indicates that a position near a third trip line was not detected by the traveler. A client process includes determining whether two trip lines are encountered in a different sequence than in an ordered plurality of trip lines received from the traffic service. If the two trip lines are in a different sequence, then sending, to the traffic service, data indicating an undetected trip line between the two trip lines.

### BACKGROUND

Service providers (e.g., wireless, cellular, etc.) and device manufacturers are continually challenged to deliver value and convenience to consumers by, for example, providing compelling network services. An example network service is providing current traffic information for navigation using a consumer's wireless device that includes a positioning system, such as the global positioning system (GPS). Traffic information is dynamic, sometimes changing dramatically over minutes. For example, congestion can develop quickly on certain road segments because of a particular accident.

One way to keep abreast of such rapid traffic changes is to have the consumer's wireless device that requests map and traffic information also provide traffic information. The consumer's current location is determined by GPS and the consumer's speed can be determined by the distance between position changes divided by the time to cover the distance. However, the network resources expended to provide the raw data, to process it, and return useful traffic data in a reasonable time can be overwhelming. The wireless device used by each consumer is typically limited in processor, storage, bandwidth, display, and battery power capacity; and frequent reports of position changes can quickly expend the battery of the wireless device, as well as expend much of the available bandwidth. Furthermore, the consumer's privacy may be compromised by frequent position updates sent over a public communications network.

Because of such limitations on the consumer's wireless device, much processing is done on the service provider equipment. The load on the service provider's equipment is also great. For example, one traffic service may comprise millions of road segments and a similar number of position updates from hundreds of thousands of consumers. Providing such a service can expend much of the resources on the equipment assigned to the service, as well, and clog valuable bandwidth in communications networks and become prohibitive as the number of consumers increases.

### SOME EXAMPLE EMBODIMENTS

Therefore, there is a need for techniques for aggregating traffic information from wireless devices of consumers, which does not suffer all the disadvantages of prior approaches. Traffic reporting triggered by a consumer's crossing of virtual trip lines has been proposed to de-couple traffic information from the travels of particular consumers. In various embodiments described herein, enriched virtual trip lines, called rich trip lines herein, are used to reduce or remove one or more other disadvantages of prior approaches.

According to one embodiment, a method comprises facilitating access, including granting access rights, to an interface to allow access to a service via a network. The service is configured to, in response to receiving data indicating a current position, determine an ordered plurality of trip lines. A trip line indicates a position where a traffic condition is to be reported to the service. The method also comprises returning data that indicates the ordered plurality of trip lines. The ordered plurality of trip lines are ordered such that a traveler encountering two trip lines of the plurality of trip lines in a different sequence indicates that a position near a third trip line was not detected by the traveler.

According to another embodiment, a method comprises determining whether two trip lines, which indicate positions where values for a traffic condition are to be reported to a traffic service, are encountered in a different sequence than in an ordered plurality of trip lines received from the traffic service. The method further comprises, if the two trip lines are in a different sequence, then sending, to the traffic service, data indicating an undetected trip line between the two trip lines in the ordered plurality of trip lines.

According to another embodiment, an apparatus comprises at least one processor, and at least one memory including computer program code, the at least one memory and the computer program code configured to, with the at least one processor, cause, at least in part, the apparatus to, in response to receiving data indicating a current position, determine an ordered plurality of trip lines that indicate positions where a traffic condition is to be reported. The apparatus is also caused to return data that indicates the ordered plurality of trip lines. The ordered plurality of trip lines are ordered such that a traveler encountering two trip lines of the plurality of trip lines in a different sequence indicates that a position near a third trip line was not detected by the traveler.

According to another embodiment, an apparatus comprises at least one processor, and at least one memory including computer program code, the at least one memory and the computer program code configured to, with the at least one processor, cause, at least in part, the apparatus to, determine based on data from a positioning system whether two trip lines, which indicate positions where values for a traffic condition are to be reported to a traffic service, are encountered in a different sequence than in an ordered plurality of trip lines received from the traffic service. The apparatus is further caused to send, to the traffic service, data indicating an undetected trip line between the two trip lines in the ordered plurality of trip lines, if the two trip lines are in a different sequence.

According to another embodiment, a computer-readable storage medium carries one or more sequences of one or more instructions which, when executed by one or more processors, cause, at least in part, an apparatus to, in response to receiving data indicating a current position, determine an ordered plurality of trip lines that indicate positions where a traffic condition is to be reported. The apparatus is also caused to return data that indicates the ordered plurality of trip lines. The ordered plurality of trip lines are ordered such that a traveler encountering two trip lines of the plurality of trip lines in a different sequence indicates that a position near a third trip line was not detected by the traveler.

According to another embodiment, a computer-readable storage medium carries one or more sequences of one or more instructions which, when executed by one or more processors, cause, at least in part, an apparatus to determine based on data from a positioning system whether two trip lines, which indicate positions where values for a traffic condition are to be reported to a traffic service, are encountered in a different sequence than in an ordered plurality of trip lines received from the traffic service. The apparatus is also caused to send, to the traffic service, data indicating an undetected trip line between the two trip lines in the ordered plurality of trip lines, if the two trip lines are in a different sequence.

According to another embodiment, an apparatus comprises means for, in response to receiving data indicating a current position, determining an ordered plurality of trip lines that indicate positions where a traffic condition is to be reported. The apparatus also comprises means for returning data that indicates the ordered plurality of trip lines. The ordered plurality of trip lines are ordered such that a traveler encountering two trip lines of the plurality of trip lines in a different sequence indicates that a position near a third trip line was not detected by the traveler.

According to another embodiment, an apparatus comprises means for determining whether two trip lines, which indicate positions where values for a traffic condition are to be reported to a traffic service, are encountered in a different sequence than in an ordered plurality of trip lines received from the traffic service. The apparatus also comprises means for sending, to the traffic service, data indicating an undetected trip line between the two trip lines in the ordered plurality of trip lines if the two trip lines are in a different sequence.

According to another embodiment, a method comprises facilitating access, including granting access rights, to an interface to allow access to a service via a network. The service is configured to determine a subset of trip lines of a full plurality of trip lines in a portion of a road map. The method also comprises returning data that indicates the subset of trip lines. A trip line indicates a position where a traffic condition is to be reported to the traffic service. Traffic conditions at the subset of trip lines are representative of traffic conditions at the full plurality of trip lines.

According to another embodiment, a method comprises receiving from a traffic service a plurality of trip lines that include normal values for a traffic condition. A trip line indicates a position where a traffic condition is to be reported to the traffic service. The method further comprises, in response to encountering a trip line, determining whether a current value of the traffic condition at the encountered trip line is abnormal by comparing the current value to the normal value for the traffic condition at the encountered trip line.

According to another embodiment, a method comprises facilitating access, including granting access rights, to an interface to allow access to a service via a network. The service is configured to, in response to receiving data indicating a current position, determine an ordered plurality of trip lines that indicate positions where a traffic condition is to be reported. The method further comprises returning data that indicates the ordered plurality of trip lines. The ordered plurality of trip lines is grouped by road segment.

According to another embodiment, a method comprises receiving an ordered plurality of trip lines from a traffic service. A trip line indicates a position where a traffic condition is to be reported to the traffic service. The ordered plurality of trip lines is grouped by road segment. The method further comprises, determining when a trip line is encountered by comparing a current position of an apparatus to successive trip lines of the ordered plurality of trip lines starting after a last trip line most recently encountered until a trip line is determined to be within a threshold distance of the current position. The method also comprises causing to be sent, to the traffic service, data that indicates a current value of the traffic condition when the trip line is encountered.

In various other embodiments an apparatus includes means for performing one or more steps of the immediately preceding four methods; or an apparatus is configured to perform one or more steps of the preceding four methods; or a computer-readable storage medium or computer program product causes an apparatus to perform one or more steps of the preceding four methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of aggregating traffic data using rich trip lines, according to one embodiment;

FIG. 2 is a diagram of a roadmap tile showing locations of trip lines, according to an embodiment;

FIG. 3A is a diagram of a tile data structure including rich trip lines, according to an embodiment;

FIG. 3B is a diagram of virtual trip line message for rich trip lines, according to an embodiment;

FIG. 3C is a diagram of a traffic message based on rich trip lines, according to an embodiment;

FIG. 4 is a flowchart of a process for a traffic service using rich trip lines, according to one embodiment;

FIG. 5 is a flowchart of a process for a traffic client using rich trip lines, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program are disclosed for aggregating traffic information using rich trip lines. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term virtual trip line refers to data that indicates where, along a road segment on a roadmap, traffic information is to be reported to a traffic service. Thus, a virtual trip line is data that serves as a metaphor for a trip wire used to trigger some mechanical device. For convenience, a virtual trip line is also called a trip line hereinafter. In some embodiments, a trip line is often specified by coordinates of endpoints of a line segment that is perpendicular to the road segment; but, in other embodiments, other data may be used, such as formula for a curve or individual pixels in a particular portion of imagery representing roadmap data. It has been shown that the use of trip lines provides significantly better coverage and requires virtually no installation or maintenance costs when compared to traditional systems that employ embedded loop detectors to determine when to send traffic information to a traffic service.

A rich trip line is a virtual trip line associated with additional data that is used in aggregating traffic information for a traffic service. For example, a plurality of trip lines for which order conveys some meaning, such as trip lines grouped by road segment, are rich trip lines different from virtual trip lines previously proposed. Similarly, trip lines associated with traffic statistics, including normal traffic conditions, are rich trip lines different from virtual trip lines previously proposed. Similarly, trip lines associated with position detection properties, such as holes in GPS coverage, are rich trip lines different from virtual trip lines previously proposed.

As used herein, a tile is an atomic portion of content that is sent from a service to user equipment for rendering on user equipment. Examples of content include a roadmap, or a roadmap with traffic information, such as road segments colored to indicate one of normal, slow or stopped traffic conditions.

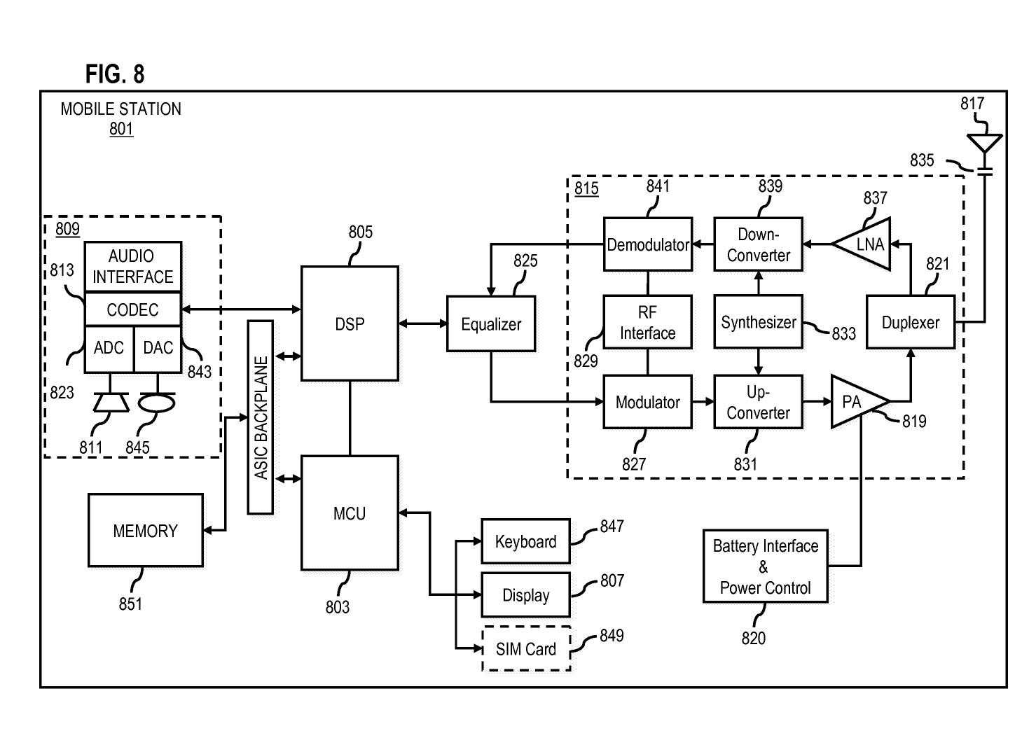

Although various embodiments are described with respect to a traffic client on a mobile telephone terminal, as depicted in FIG. 8, it is contemplated that the approach described herein may be used with other platforms, such as desktop personal computers, lap top computers, stand alone navigation systems, personal digital assistants (PDAs) and other devices connected to a traffic service over a communications network.

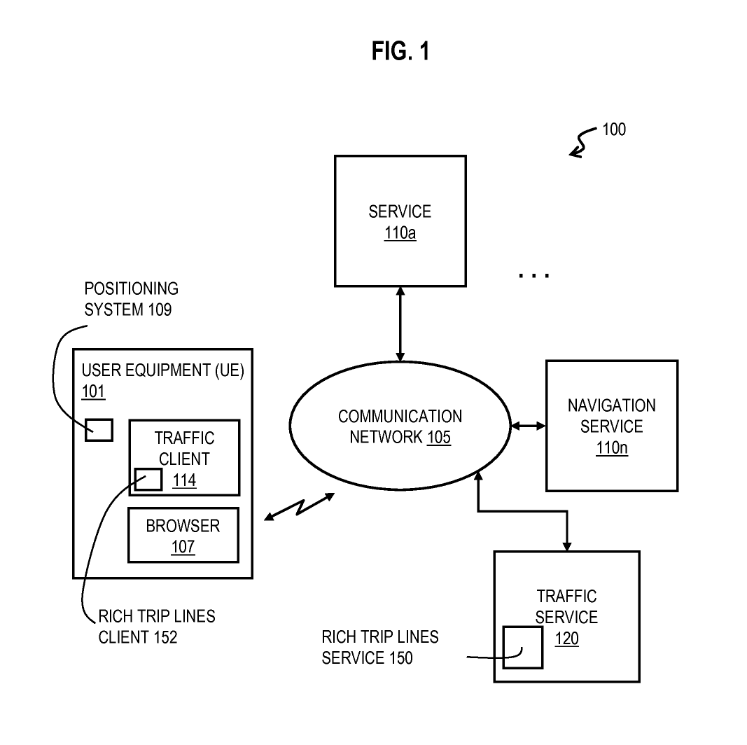

FIG. 1 is a diagram of a system 100 capable of aggregating traffic data using rich trip lines, according to one embodiment. Previous embodiments of virtual trip lines were unable to detect holes in the traffic data caused by poor positioning system signal recognition, such as poor GPS signals in the presence of interferences, as occurs in spots within areas of high rise buildings, strong radio transmitting antennas, tunnels, heavy tree cover, dense clouds, ionosphere disruptions and complex geological structures. Furthermore, trip lines used in previous embodiments were established to provide comprehensive coverage; and a relatively large number of trip lines are employed in dense street grids and roads carrying two-way traffic. Sending such comprehensive sets of trip lines expends substantial network bandwidth in communicating to devices of a large number of consumers. Furthermore, checking a current position of a consumer device against a large number of trip lines expends substantial processing power and battery life on the consumer device. In addition, reporting consumer device position at a larger number of trip lines compromises the user's privacy expectations while traveling more than does reporting position at fewer trip lines.

To address one or more of these problems, a system 100 of FIG. 1 introduces the capability to aggregate traffic information using rich trip lines. As shown in FIG. 1, the system 100 comprises user equipment (UE) 101 having connectivity to one or more network services, such as network service 110a through navigation service 110n (collectively referenced hereinafter as network services 110) and a traffic service 120 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, network services 110 and traffic service 120 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages.

In the illustrated embodiment, the UE 101 includes a positioning system, such as a GPS positioning system (GPS), a browser 107 and a traffic client process 114, such as a process within a different client process for one or more of servers providing network services 110, such as navigation service 110n. The traffic client process 114 receives traffic data directly from traffic service 120 or indirectly from one of the network services 110, such as navigation service 110n, and determines traffic at one or more road segments including traffic at the current position of UE 101

According to various embodiments, the traffic service 120 includes a rich trip lines service module 150; and the traffic client 114 includes a rich trip lines client module 152. The rich trip lines service module 150 is configured to determine one or more rich trip lines, or order, or both, for a tile being sent to the UE 101. The rich trip lines service module 150 also is configured to receive, from the UE 101, data that indicates traffic conditions at one or more trip lines. The traffic conditions received from UE 101 are used by the traffic service 120 to determine traffic for one or more road segments in a tile. According to some embodiments, the traffic conditions are also used by the rich trip lines service module 150 to characterize the normal and abnormal traffic conditions expected at one or more trip lines, or subset the trip lines sent to the client, or determine holes in the position system coverage, or some combination, as described in more detail below.

The rich trip lines client module 152, uses the order of trip lines received by the navigation client process 114 to reduce the number of trip lines checked, or uses other rich trip line information to detect abnormal traffic conditions, or report trip lines affected by holes in the positioning system, or some combination. The module 152 also causes the traffic data to be reported back to the traffic service 120, either directly or indirectly though the traffic client process 114.

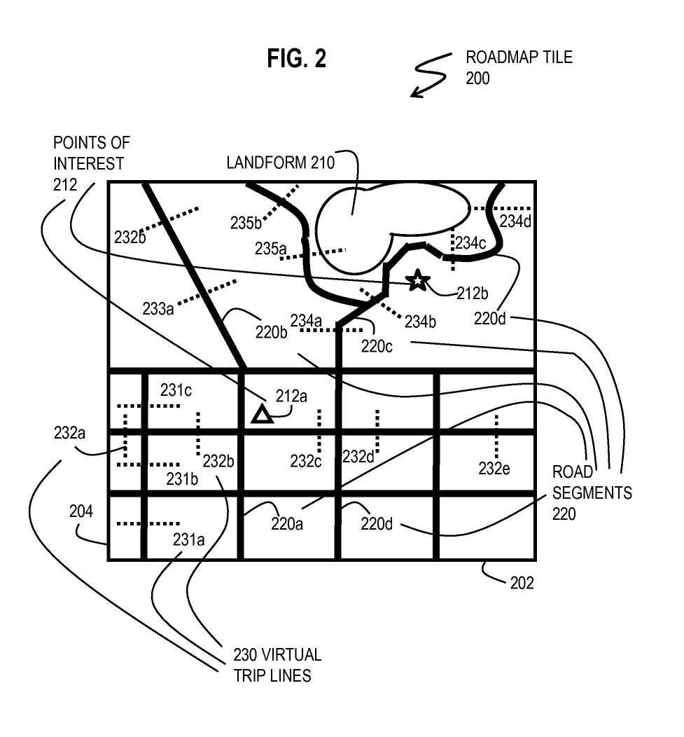

FIG. 2 is a diagram of a roadmap tile 200 showing locations of some trip lines, according to an embodiment. The roadmap tile 200 includes rows of picture elements (pixels) arranged in a horizontal dimension 202 and columns of pixels arranged in a vertical dimension 204. The pixels represent map information, such as landform 210 (e.g., a lake or park), and one or more points of interest 213a and 212b, collectively referenced hereinafter as pointes of interest 212, such as a bank or theater. The tile 200 also includes pixels representing road segment 220a, road segment 220b, road segment 220c and road segment 220d, among others, collectively called road segments 220 hereinafter. For purposes of illustration, it is assumed that this tile is identified by two indices and a zoom level value.

For purposes of illustration, data indicating virtual trip lines 230 are depicted as dotted lines on roadmap tile 200, but these trip lines are not actually rendered on UE 101. Trip line 230 includes trip lines 231a, 231b, 231c, 232a, 232b, 232c, 232d, 232e, 233a, 233b, 234a, 234b, 234c and 234d. The illustrated virtual trip lines 230 are line segments represented in computer memory as a pair of endpoints, each endpoint indicated by a pair of coordinate values, one for the horizontal dimension 202 and the other for the vertical dimension 204. The depicted trip lines 230 are approximately perpendicular to the road segments they intersect, but in other embodiments any nonzero angle may be used between the line segment indicating the trip line and the road segment. To avoid obscuring the diagram, not all trip lines are depicted.

Typically, the current position of the UE 101 is tracked using a positioning system co-located with the UE 101 (e.g., built in positioning system 109 or in the same vehicle) at a regular sampling interval, e.g., every three (3) seconds. However, a traffic condition is not reported on the same interval. Only when a current position encounters a trip line is a traffic condition reported to the traffic service 120. Typically, the traffic condition reported is speed, which is determined by dividing the distance covered from the previous position divided by the sampling interval (e.g. three seconds) and converted, if desired, to any speed units of interest (e.g., miles per hour). The encounter with a trip line is detecting by determining the distance from the current position of the UE 101 to each of the trip lines and determining whether the minimum distance is within a threshold distance (e.g., less than a threshold distance of 50 meters). If there are hundreds of trip lines on a tile, the computation of distance to every trip line repeated every sampling interval can expend substantial resources on the UE 101. Confining trip lines to those on the current road segment or those that convey the most useful traffic information is desirable. Useful traffic information may depend upon whether traffic conditions are normal or abnormal.

Furthermore, some trip lines, e.g., trip line 232b may be located in a hole of the positioning system coverage. Leaving the trip line positioned in such a hole is a waste of the resources expended to send the trip line and check the distance, as a current position is rarely detected when the UE 101 is within the threshold distance of 232b. Therefore the trip line should be dropped or moved. Therefore it is desirable for the UE 101 to report when successive intersections with two trip lines skip an intervening trip line. To determine when intervening trip lines are skipped, it is advantageous for the trip lines to be provided, e.g., by the traffic service 120, in order of expected encounter.

According to various embodiments described in more detail below, rich trip lines are used to aggregate traffic information. Each rich trip line is associated with enriched data, such as an order, a road segment, positioning system performance data, or a normal traffic condition, or some combination.

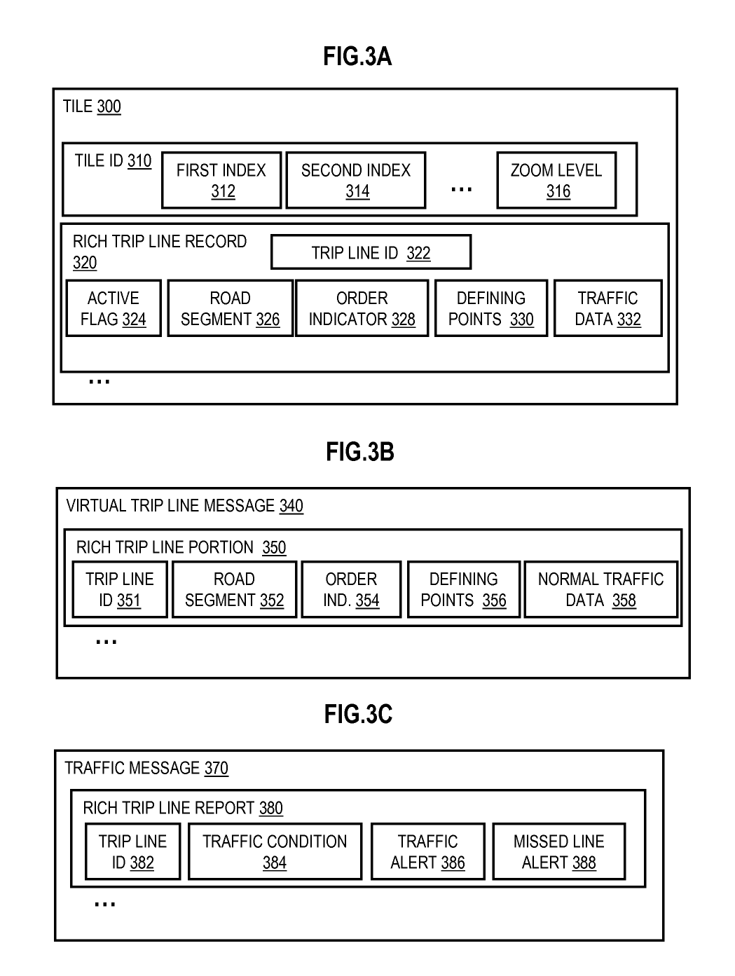

FIG. 3A is a diagram of a tile data structure 300 including rich trip lines, according to an embodiment. Although data structures, messages and field are shown in FIG. 3A, and in subsequent diagrams FIG. 3B and FIG. 3C, as integral blocks in a particular order for purposes of illustration, in other embodiments, one or more data structures or messages or fields, or portions thereof, are arranged in a different order in one or more databases or data structures on one or more nodes in communication with network 105 or in one or more messages. In some embodiments, one or more fields or portions thereof are omitted, or other fields are added, or the data structures or messages are changed in some combination of ways.

Tile data structure 300 represents one tile of a plurality of tiles in a tile cache data structure, and includes a tile identifier (ID) field 310 and one or more rich trip line record fields 320. The tile ID field 310 holds data that uniquely identifies a tile. In an illustrated embodiment for map or traffic tiles, the tiles comprise a two dimensional array of two-dimensional tiles at each of multiple scales (called zoom levels herein); and a tile is uniquely identified by a first index spanning all longitudes of interest, a second index spanning all latitudes of interest, and a zoom level with different amounts of detail at different zoom levels. In such embodiments, a tile ID field 310 includes a first index field 312 holding data that indicates a value for the first index, a second index field 314 holding data that indicates a value for the second index, and a zoom field 316 holding data that indicates a value for the zoom level. In other embodiments, more indices, indicated by the ellipsis, or fewer indices are used to identify the tile.

The rich trip line record field 320 holds data that indicates a trip line in the tile along with enriched data associated with the trip line. In the illustrated embodiment, the rich trip line record 320 includes a trip line identifier (ID) field 322, and active flag field 324, a road segment identifier (ID) field 326, an order indicator field 328, a defining points field 330 and a traffic data field 332. In other embodiments one or two of fields 326 or 328 or 332 are omitted. The trip line ID field 322 holds data that uniquely indicates a particular virtual trip line.

The active flag field 324 holds data that indicates whether the trip line should be sent when a roadmap tile is sent to user equipment, such as to UE 101. As described in more detail below, a trip line is active, and therefore sent with a tile, when it is likely to provide traffic information that is not cumulative with traffic information associated with other active trip lines in the tile. The active flag field 324 is a rich trip line field that provides the advantage of reducing the number of trip lines sent from the traffic service and thus conserving network bandwidth. Simultaneously, the active flag field 324 also reduces the number of distances computed by the traffic client to determine when user equipment encounters a trip line, thus conserving computing resources and battery life on the user equipment. The active flag field 324 is an example means to achieve these advantages.

The road segment field 326 holds data that indicates a road segment in the tile which crosses the trip line indicated by field 322. Any method may be used to indicate the road segment, such as a pointer to a road segment record or the pair of two-dimensional coordinates that define the endpoints of the road segment. For example, trip line 234a crosses and is associated with road segment 220c in roadmap tile 200. The road segment field 326 is a rich trip line field that provides an advantage in limiting the number of trip lines to be searched for an encounter. For example, instead of computing distance to all trip lines and finding the minimum, a traffic client starts with computing distance to the trip lines on the same road segment where an encounter is more likely to be found and then on adjacent road segments, and then on road segments adjacent to those. As distance to trip lines on other road segments increases, it can be safely concluded that no intersection is likely and the computations can stop. Thus, grouping trip lines by road segment provides the advantage of conserving computing resources and battery life on the user equipment. The road segment field 326 is an example means to achieve this advantage.

The order indicator field 328 holds data that indicates an order for trip lines along a road segment identified in field 326 in one direction. Any method may be used to indicate the order, such as sequence numbers or a pointer to the next trip line ID in order. For example, trip line 234b, trip line 234c and trip line 234d cross and are associated with road segment 220d in roadmap tile 200. The trip line record 320 for trip line 234d includes in order indicator field 328 data that indicates the value 3, meaning that trip line 234d is the third trip line going north along road segment 220d. The order indicator field 328 is a rich trip line field that provides an advantage of supporting a determination of whether a trip line is missed. For example, if trip line 234d is encountered after trip line 234b is encountered, then trip line 234c has been skipped. Skipping a trip line indicates that there might be a positioning system hole at trip line 234c. This can be reported back to the traffic service which can determine whether to drop or move trip line 234c. This allows ending wasteful expenditures of network bandwidth and computations on the traffic client for the trip line in a positioning system hole. The order indicator field 328 is an example means of achieving the advantage of detecting holes in the positioning system at a trip line.

Defining points field 330 holds data that indicates one or more pairs of coordinates that define the trip line, such as one pair of coordinates at each endpoint of a line segment that represents the trip line.

The traffic data field 332 holds data that indicates the historical and current traffic conditions at the trip line. Any traffic condition can be used to characterize the traffic at a trip line, such as the speed of user equipment at the trip line or the acceleration of the user equipment at the trip line (the time rate of change of speed), or the direction of movement or direction of acceleration. For purposes of illustration it is assumed that speed is the traffic condition of interest. The traffic conditions is related to one or more properties of the measurement, such as the position and or altitude of the user equipment when the traffic condition was reported and the time when the traffic condition was reported and the accuracy of the traffic condition measurement (e.g., number of satellite signals or strength of satellite signals). In some embodiments, the traffic data includes a histogram of number of reports in each of several value ranges (bins) for the traffic conditions, such as several speed bins. In some embodiments, such histograms are generated for each of one or more periods of time, as well as the distribution of the traffic condition values in a most recent traffic reporting period.

Such data allows the determination of normal and abnormal traffic conditions, at each of several time periods to determine differences in normal conditions at different time periods, such as rush hours during weekdays, midday and night time periods, weekend and holiday periods, and summer and winter periods. During normal traffic conditions, measurements at a few trip lines can be good predictors of traffic conditions at other trip lines, so fewer trip lines can be used to characterize traffic in the roadmap tile. During abnormal conditions, however, the few trip lines may be poor predictors, and measurements are needed at more trip lines to characterize traffic in the tile. Thus the traffic data field 332 is an example means to obtain the advantage of detecting normal traffic conditions when fewer trip lines are able to characterize traffic in a tile, allowing fewer trip lines to be sent to traffic client processes during normal conditions, and saving network bandwidth as well as computations of trip line encounters on the user equipment.

FIG. 3B is a diagram of virtual trip line message 340 for rich trip lines, according to an embodiment. Message 340 is sent to user equipment in response to receiving a request for a tile that includes a current position of the user equipment, e.g., of built-in positioning system 109 or other positioning system co-located with the user equipment. In the illustrated embodiment, the virtual trip line message 340 includes a rich trip line portion 350 for each trip line in the tile that encompasses the current position of the user equipment. Each trip line portion includes a trip line ID field 351, a road segment ID field 352, an order indicator field 354, a defining points field 356 and normal traffic data 358.

The trip line ID field holds data that uniquely indicates the trip line, such as in trip line ID field 322. Similarly, the road segment field 352 holds data that indicates the associated road segment crossed by the trip line, as in road segment field 326; and the order indicator field holds data that indicates the order on the road segment as in order indicator field 328. The defining points field 356 holds data indicating the points that define the trip line, as in defining points field 330. These fields are example means to provide the advantages described above for related fields in rich trip line record 320.

The normal traffic data field 358 holds data that indicates normal traffic conditions, such as an average speed or a speed range or an average speed and standard deviation. The normal traffic conditions exclude abnormal traffic conditions during periods of unusual slowdowns or stoppages. The normal conditions are included in the traffic data field 332 and based on analysis of the histogram also included in the traffic data field 332, using any methods known in the art to distinguish normal from abnormal conditions, such as cluster analysis. The normal traffic conditions are used by the traffic client to detect when conditions are normal and can be represented by active trip lines that are a subset of all the trip lines, or when conditions are abnormal so that it is useful to activate more or all the trip lines in the tile. The normal traffic field is an example means to achieve the advantage of reducing bandwidth and processing and battery resources during normal traffic conditions.

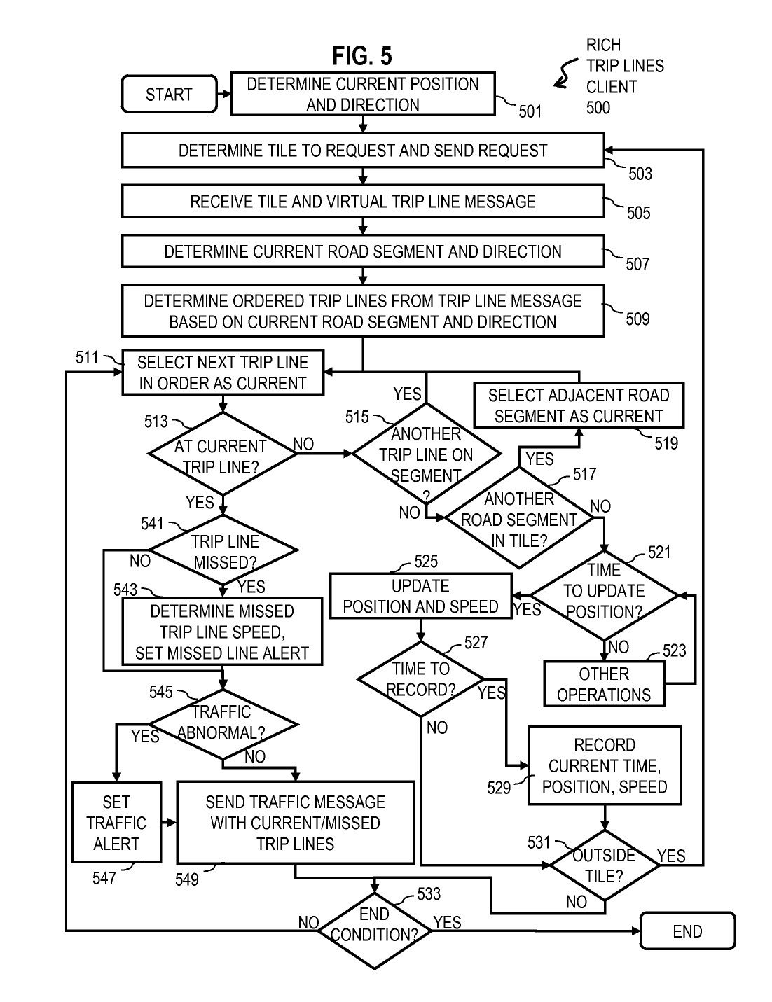

FIG. 3C is a diagram of a traffic message 370 based on rich trip lines, according to an embodiment. The traffic message 370 is sent when the traffic client detects an encounter of the current position of the user equipment with any trip line sent in the trip line message 340. The traffic message 370 includes rich trip line report fields 380 for one or more trip lines, such as the trip line encountered by the current position and zero or more skipped trip lines. A skipped trip line indicates missed position detections and possible holes in the positioning system, as described in more detail below with reference to FIG. 5. Each rich trip line report 380 includes a trip line ID field 382, a traffic condition field 384, a traffic alert field 386, and a missed line alert field 388.

The trip line ID field 382 holds data that uniquely indicates the trip line, such as in trip line ID field 322 and field 351. The traffic condition field 384 holds data that indicates the traffic condition detected or interpolated by the user equipment at the time and position when the trip line was encountered, such as the speed or direction or acceleration or position system signal quality or some combination.

The traffic alert field 386 holds data that indicates whether the traffic condition in field 384 is outside normal traffic conditions, as determined by comparing the value in field 384 with the value or values in field 358 for the same trip line. In some embodiments, the traffic alert field 386 is a bit that has one value for normal conditions and a different value for abnormal conditions. During normal conditions the traffic service sets a subset of fewer than all trip lines in a tile as active, e.g., by setting the active flag field 324 to a value that indicates active. During abnormal conditions additional trip lines, such as all trip lines, are set active.

The missed line alert field 388 holds data that indicates whether an encounter with the trip line indicated in field 382 was not detected. This can be determined by the traffic client if the trip line preceding and following the trip line in field 382, as indicated by the order indicator in field 354, were encountered without an encounter of the trip line indicated in field 382. For example, if encounters are detected at trip lines 234b and 234d, in order, then trip line 234c was missed, i.e., skipped. In some embodiments, the missed line alert field 388 is a bit that has one value for a detected trip line encounter and a different value for a skipped trip line. The missed line alert field is an example means to achieve the advantage of detecting holes in a positioning system so that a trip line can be eliminated or moved by the traffic service, thus getting more information per data bit transmitted over the communications network and per processing step and battery life on the user equipment.

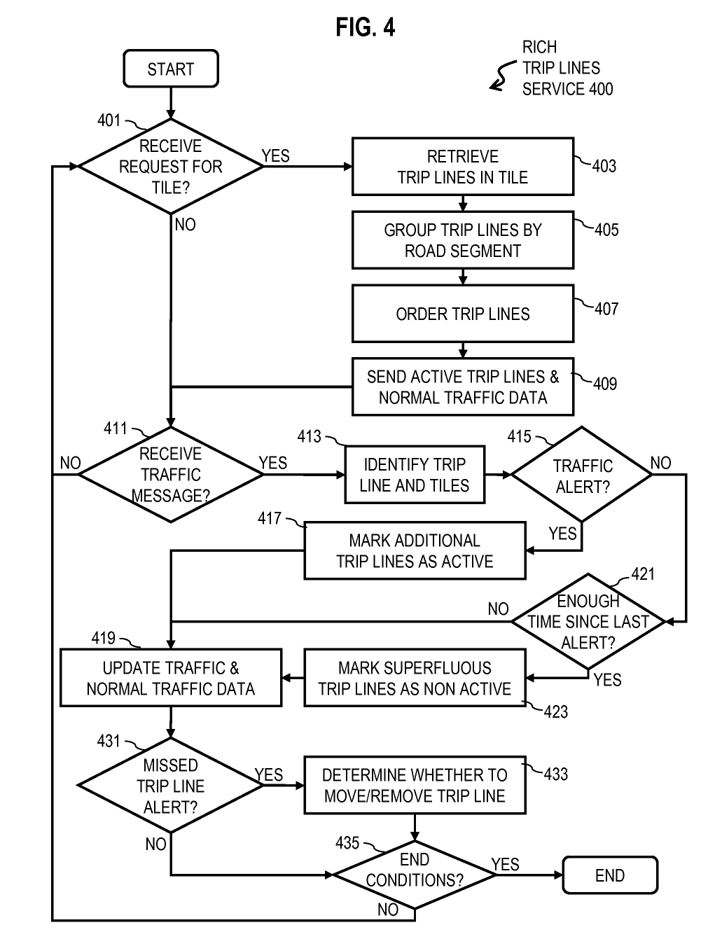

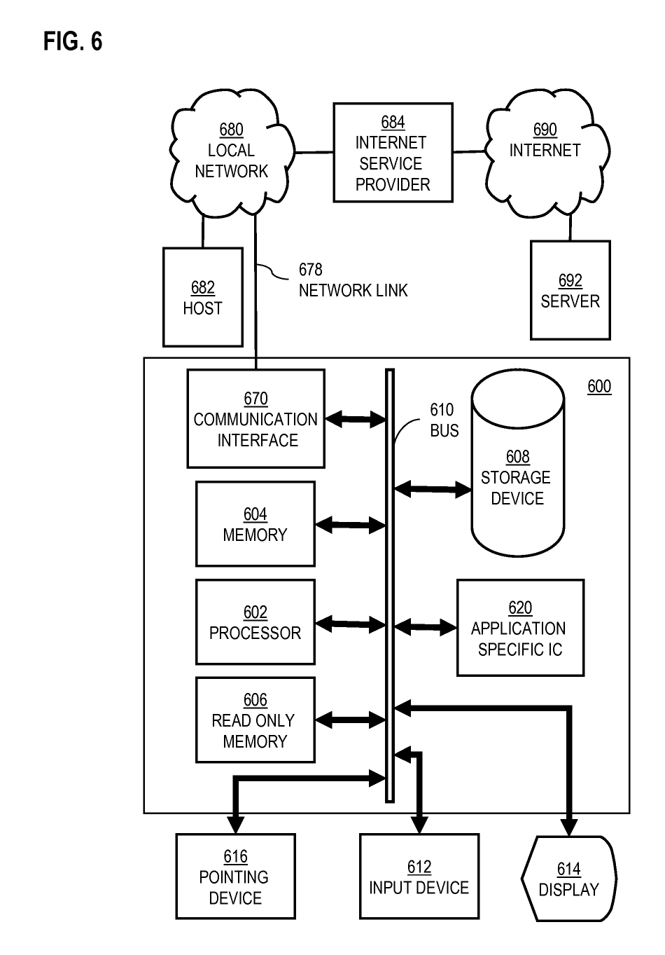

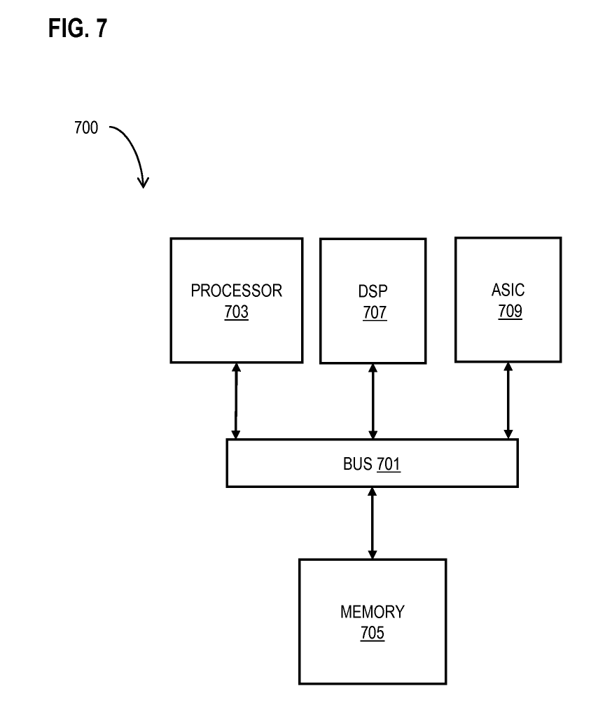

FIG. 4 is a flowchart of a process 400 for a traffic service using rich trip lines, according to one embodiment. In one embodiment, the rich trip line service module 150 performs the process 400 and is implemented in, for instance, a chip set including a processor and a memory as shown FIG. 7 or a general purpose computer depicted in FIG. 6. Thus the rich trip line service module 150 facilitates access, including granting access rights, to an interface to allow access to the service provided by module 150 via the network 105.

Although steps are shown in FIG. 4, and in subsequent flow chart FIG. 5, as integral blocks in a particular order for purposes of illustration, in other embodiments, one or more steps or portions thereof are performed in a different order or overlapping in time, performed in series or in parallel, or one or more steps are omitted, or other steps are added, or the method is changed in some combination of ways.

In step 401, it is determined whether a request for a tile has been received from user equipment of a consumer. The request indicates a network address for the traffic client 114 on the user equipment 101 and a current position of the user equipment, either as coordinates of the position of the user equipment or as a block area of interest or as a tile ID of one or more tiles being requested or some combination. In step 403, the trip lines associated with the block area or tile or tiles requested are retrieved, e.g., from tile data structure 300.

In step 405 the trip lines are grouped by road segment, e.g., sorted by values in road segment field 326. In some embodiments, the trip line rerecords 320 are stored in road segment order and step 405 is inherent in step 403. Thus, in response to receiving data indicating a current position, the rich trip line service module 150 determines an ordered plurality of trip lines that indicate positions where a traffic condition is to be reported, wherein the ordered plurality of trip lines are grouped by road segment. In some embodiments step 405 is omitted. By grouping trip lines by road segment, the advantage is achieved of focusing computations of trip line encounters on the user equipment to trip lines on the same road segment, more likely to be encountered next. Thus an encounter is found faster, and computations are ended sooner, saving processor resources and battery life on the user equipment. Step 405 is an example means to achieve this advantage.

In step 407, trip lines are ordered so that a traveler encountering two trip lines of the trip lines in the tile in a different sequence can deduce that a position near a third trip line was not detected. Any method may be used to order the trip lines for this purpose. In an example embodiment, the trip lines are ordered by road segment and direction of travel, and trip lines on adjacent road segments that join with a current road segment follow in order after the trip lines on the current road segment. After the last trip line on one segment, the next trip line is most likely to be the first trip line on one of the road segments that join the current road segment at the road segment end point toward which the traveler (e.g., the user equipment) was last moving.

For example, for a northbound traveler, after trip line 234a on road segment 220c, the next trip line in order is one of the set including trip line 234b on road segment 220d or trip line 235a on a different road segment. If the next trip line detected is 234c, then trip line 234b was skipped. Similarly, if the next trip line detected is 235b, then trip line 235a was skipped. Given the current road segment and direction, the rich trip line service module 150 can determine an order for the trip lines in the tile. Similarly, a southbound traveler that intersects trip line 231c should next intersect one of trip line 232a or trip line 232b or trip line 231b. In some embodiments, the trip line records 320 are stored in order and step 407 is inherent in step 403.

As used herein, a set of virtual trip lines is an ordered set S of virtual trip lines T1, T2, . . . , Tn on a road network such that a mobile client should encounter Ti before encountering Tj on the road network if Ti precedes Tj in S. One can view S as a directed graph G of vertices V and edges E. G=(V, E) such that Ti is in V if Ti is in S and edge e=(Ti, Tj) is in E if Ti immediately precedes Tj in S. Joints in road segment networks are included by including trip lines before endpoints of road segments several times, once with the first trip line on each road segment joined at the endpoint. Ordered trip lines essentially create a virtual path for the client. If a client previously detected an encounter on trip line Ti and the next detected an encounter with Tj, then if e=(Ti, Tj) is not in E the client can infer that the client has missed detecting encounters on the subset of skipped virtual trip lines S1. A trip line Tk is in skipped subset S1 if Tk follows Ti in S and Tk precedes Tj in S. That is, S1 is the subset of skipped virtual trip lines between Ti and Tj on the client's path. In some embodiments, not only are the vertices T1, T2, . . . Tn sent, but also, or instead, one or more edges in E are also sent to accommodate joints in the road segment network.

In some embodiments, the rich trip lines service module 150 maintains a database of ordered virtual trip lines. In these embodiments, each trip line record in the database contains the following fields: TriplineID (Trip line identifier), TriplinePos1 (Longitude and latitude of the start of trip line), TriplinePos2 (Longitude and latitude of the end of trip line), and TriplineNextInChainID (The next trip line in the order). For example, TriplineID is stored in trip line ID field 322. TriplinePos1 and TriplinePos2 are stored in defining points field 330. In these embodiments, TriplineNextInChainID is stored in order indicator field 328, with multiple entries in the field 328 for the last trip line on each road segment, pointing to the first trip line on each of the road segments joined to the road segment indicated in field 326. In some embodiments, the request is received from the client process with a bounding box B that defines a current map view on the user's mobile device. On receiving the request, the server issues a query on the trip line database to retrieve all ordered virtual trip lines that intersect with B, and the results are retrieved in step 407.

Even if the traveler makes an unusual move, such as making a U turn, the ordered list of trip lines will detect skipped trip lines under most circumstances, sufficient for the purposes presented here. Thus, in response to receiving data indicating a current position, the rich tile service module 150 determines an ordered plurality of trip lines, wherein the ordered plurality of trip lines are ordered such that a traveler encountering two trip lines of the plurality of trip lines in a different sequence indicates that a position near a third trip line was not detected by the traveler. In some embodiments, trip lines are not ordered and step 407 is omitted.

In step 409 the active trip lines in the tile are sent to the traffic client 114 on the user equipment 101 which sent the request received in step 401, e.g., in virtual trip line message 340. In some embodiments, step 409 includes determining normal traffic conditions for each trip line from the traffic data field 332 associated with each trip line, and including the normal traffic conditions in the normal traffic data field 358 of the virtual trip line message 340. In such embodiments, step 409 is an example means to achieve the advantage of detecting abnormal conditions when more trip lines should be sent to the traffic client processes, e.g., traffic client process 114.

In some embodiments, not all trip lines stored in tile data structure 300 for the requested tile are sent in step 409, only those marked active are sent. In some embodiments, the number marked active depends on whether traffic conditions on a subset of fewer than all trip lines are representative of traffic conditions at the full set of trip lines. If so, then, in some embodiments, only those trip lines that are representative of all the trip lines are marked active and the others are marked inactive, as described in more detail below with reference to step 423. On startup or before a representative set of trip lines is determined, all trip lines in a tile are active.

Thus, in some embodiments, in step 409 the rich trip lines service module 150 causes data that indicates the ordered plurality of trip lines to be returned. In some embodiments, in step 409 the rich trip lines service module 150 causes data that indicates an ordered plurality of trip lines grouped by road segment to be returned. In some embodiments, in step 409 the rich trip lines service module 150 causes data that indicates the subset of trip lines to be returned. In various embodiments, data that indicates trip lines ordered by road segment, or ordered to detect skipped trip lines, or a non-ordered subset of active trip lines with normal traffic conditions, or some combination is returned.

In step 411, it is determined whether a traffic message (e.g., traffic message 370) is received from user equipment, e.g., from traffic client 114 on UE 101. If not, control passes between steps 401 and 411 until some request is received that merits a response from the rich trip line service module 150.

If it is determined in step 411 that a traffic message is received from user equipment, then in step 413 the one or more trip lines and the tiles in which they appear are identified. For example, a currently encountered trip line and zero or more skipped trip lines are indicated in the traffic message 370 and used in step 413 to identify one or more tiles that includes the one or more trip lines in tile data structure 300.

In step 415, it is determined whether the traffic message includes data that indicates a traffic alert. For example, it is determined whether a value in traffic alert field 366 indicates a traffic alert. In some embodiments, the traffic alert field 386 is omitted; and the rich trip line service module 150 determines abnormal conditions based on the value in the traffic condition field 384 and the statistics in the traffic data field 332. Thus the rich trip line service module 150 is further configured to receive data that indicates a traffic condition at a trip line of the ordered or non-ordered subset of the plurality of trip lines. Furthermore, the service is further configured to determine whether a reported traffic condition at a trip line is substantively different from normal traffic conditions.

If it is determined in step 415 that conditions indicate a traffic alert, then, in step 417, any inactivated trip lines represented by traffic conditions at the trip line indicated in field 382 are marked as active, e.g., by setting a value that indicates activation in the active flag field 324 of each such represented trip line record. Thus, when the service module 150 receives client notification of an observed change in expected values, the service module 150 resets the activation bit (e.g., to 1 to indicate active) for the complete set of virtual trip lines for which the trip line indicated in field 382 is representative, such as all trip lines in the tile or other trip lines on the same road segment or adjacent road segments. Thus, the ordered or non-ordered plurality of trip lines includes the full plurality of trip lines in the vicinity of the current position in response to the rich trip line service module 150 receiving data that indicates the traffic condition at the trip line is substantively different from normal traffic conditions. Therefore, step 417 is an example means to achieve the advantage of reducing bandwidth and user equipment processing and battery resources by using a full set of trip lines only under abnormal traffic conditions that are, by definition, less frequent than normal traffic conditions. Control then passes to step 419.

In step 419, the traffic data associated with the trip line indicated in field 382 is updated in traffic data field 332. Occasionally, or each time, the normal conditions are also updated during step 419. For example, statistical data is gathered on trip lines for pre-determined time windows, such as, the average speed between 10 am and 11 am on weekdays (either separately gathered or grouped). During step 419, a minimal representative subset (MRS) of trip lines is also identified, each time or on occasion. The MRS is a subset of all trip lines S in a tile such that the observed traffic condition for the trip lines in the MRS is “representative” of the full set S of trip lines.

For example, given a time window t, it is determined that S₁ is the minimal representative subset of speed in S if S1 is a subset of S and the average speed of trip lines in S is v and the average speed of trip lines in S1 is also v. In another example, given a time window t, it is determined that S1 is the minimal representative subset of speed in S if S1 is a subset of S and the average speed of trip lines in S1 is v and the average speed of trip lines in S is a fixed multiplier M of v, i.e., the average speed in S is M*v. In another example, given a time window t, it is determined that S1 is the minimal representative subset of speed in S if S1 is a subset of S and the average speed of trip lines in S1 is v and the average speed of trip lines in S at other road segments is a road segment specific fixed multiplier Ms of v, i.e., the average speed at road segment in S is Ms*v.

Thus the rich trip line service module 150 is further configured to determine a subset of trip lines of a full plurality of trip lines in a vicinity of the current position wherein traffic conditions at the subset of trip lines are representative of traffic conditions at the full plurality of trip lines in the vicinity. The MRS is used to ensure that traffic is following the expected pattern and to detect when traffic conditions have changed from the expected. Therefore, step 419 is an example means to obtain the technical advantage of reducing the number of trip lines to send when traffic conditions at one or more trip lines are representative of traffic conditions at several other trip lines.

If it is determined in step 415, that traffic is not abnormal, then in step 421 it is determined if enough time has passed since the last alert to assume that traffic has returned to normal. If not, then the activated trip lines remain active, and control passes to step 419. In some cases representative subset S₁ and set S are redefined during step 419.

However, if it is determined that sufficient time has passed without an alert for abnormal traffic, then in step 423 the superfluous trip lines are marked as not active. For example, after one hour of no new alerts at a trip line in S, the trip lines in set S, which are not also part of representative subset S1, are marked as inactive in active flag field 324. Hence, after receiving a notification from one client (e.g., rich trip line client module 152 on UE 101), the server replies to subsequent client requests from the same or other user equipment with the full set of trip lines for the relevant road segment or segments, until the service module 150 detects that the traffic has returned to “normal”, for example, when it does not receive any more notifications of abnormal traffic for trip lines on the affected one or more road segments. Therefore step 423 is an example means to achieve the advantage of reducing trip lines sent to user equipment, and thus to conserve network bandwidth and processing and battery resources on user equipment.

After step 419, it is determined in step 431 whether the trip line record 380 in the traffic message 380 is for a skipped trip line, e.g., because of a value in missed trip line alert field 388. If not, then control passes to step 435 to determine if conditions are satisfied for ending the process. If so, then the process ends. Otherwise, control passes back to steps 401 and 411, described above, to determine if messages are received from a client process on user equipment.

If it is determined, in step 431, that the trip line record 380 in the traffic message 380 is for a skipped trip line, then in step 433 it is determined whether to move or remove the trip line. If a large percentage, e.g., greater than about 80%, of the traffic conditions for a trip line are skipped trip lines, then it may be concluded that the trip line is poorly placed, e.g., in a tunnel or below dense tree cover, and the trip line should be moved or removed. If another trip line is sufficiently close, e.g. within about 500 m, to another trip line that is usually not skipped, then it may be determined to delete the trip line, i.e., to remove the associated trip line record 320 from the tile data structure 300. Thus, the rich trip line service module 150 is further configured to change a particular trip line in response to receiving data indicating that a position near the particular trip line was not detected.

FIG. 5 is a flowchart of a process 500 for a traffic client using rich trip lines, according to one embodiment. In one embodiment, the rich trip lines client module 152 performs the process 500 and is implemented in, for instance, a chip set including a processor and a memory as shown FIG. 7 or a general purpose computer depicted in FIG. 6 or a mobile terminal depicted in FIG. 8.

In step 501, the traffic client 114 or rich trip line client module 152 therein determines the current position of the user equipment, e.g., by querying a positioning system co-located with the user equipment, such as a built in positioning system 109. In step 503, the traffic client 114 determines one or more roadmap tiles to request and sends the requests to the traffic service 120. In some embodiments, the traffic client 114 sends coordinates of a bounding box B and the traffic service 120 determines what one or more tiles that intersect the bounding box. In step 505, the traffic client receives the tile of roadmap pixels and one or more virtual trip line messages, with rich trip line information. The rich trip line information is passed to the rich trip lines client module 152.

In step 507, the rich trip line client module 152 determines the current road segment and direction based on the current position and direction. In step 509, the rich trip line client module 152 determines the ordered trip lines, if any, from the trip line message based on the current road segment and direction. For example, the rich trip line client module 152 determines where it is in graph G, if the trip lines are ordered within a road segment.

The client finds which virtual trip line, if any, was encountered by checking the current position of the user equipment against the set of trip lines retrieved from the server. Because the trip lines are ordered in some embodiments, the client also maintains the identifier of the last trip line it encountered, called herein the last valid trip line (LVT) for such embodiments. On each subsequent trip line check, the client only checks trip lines in order after the LVT and subsequently updates the LVT when an encounter is detected. The current LVT is determined as follows. Let the current LVT be T1 and the new LVT to be stored be T2. A bounding box B is determined based on the user equipment current position; and the rich trip line client module 152 checks only those trip lines in order after LVT that are within B. The checking stops when a trip line encounter is detected in the set S of trip lines within B or when S has been exhausted. T1 (LVT) is set to the encountered trip line, or, if S is exhausted, T1 (LVT) is retained unchanged. In some embodiments, a size of bounding box B is based on the time since the LVT and the average speed of the user equipment as deduced from the positioning system.

In steps 511 through 519 the rich trip line client module 152 determines the next trip line encountered according to another embodiment. In step 511 the next trip line in the ordered trip lines is selected as the current candidate trip line to be checked, such as the first trip line associated with the current road segment.

In step 513, it is determined whether the current position encounters the current candidate trip line, e.g., by determining that a distance between the current position and the current candidate trip line is less than some threshold value, such as 50 meters, m. Any threshold may be used, such as a threshold from about 10 m to a threshold of about 200 m. In some embodiments, an analytical solution for the intersection of two line segments is used to see if a line segment defined by the last two positions of the user equipment has an intersection with the current candidate trip line, and if so, the user equipment is determined to have encountered or intersected the current trip line, and that trip line becomes the last valid trip line (LVT).

If not, then in step 515, it is determined if there is another trip line on the same road segment. If so, then the next trip line is made the current candidate trip line in step 511 and the check for encountering is applied again in step 513. If there is not another trip line on the same road segment, then, in step 517, it is determined whether there is another road segment in the bounding area B, such as the current roadmap tile. If so, then, in step 519, the next adjacent road segment in the bounding area B or tile is selected as the current road segment.

In some embodiments, the next adjacent road segments can be determined by the multiple edges from the last trip line on the last road segment. Control passes back to step 511 to select the next ordered trip line on the new current road segment. In some embodiments, the trip lines are grouped by road segment but not ordered within the segments. In some embodiments, the trip lines are not ordered at all; and all road segments in bounding box B are checked in any order; and steps 515 and 517 and 519 are omitted. One advantage of checking in order, either by road segment or within road segments, is that an encountered trip line, if any, is likely to be found faster, thus saving computation resources and battery power on the user equipment. Ordering within road segments also provides the advantage of detecting skipped trip lines due to holes in positioning system coverage, as described in more detail below. Step 515 and step 517 and step 519 are example means of achieving these advantages.

Thus, in some embodiments, the rich trip line client module 152 determines when a trip line is encountered by comparing a current position of an apparatus to successive trip lines of the ordered plurality of trip lines starting after a last trip line most recently encountered until a trip line is determined to be within a threshold distance of the current position.

If an intersection is not found with any trip line in the bounding box B, such as the current tile (for example if it is determined in step 517 that there is not another road segment), then control passes to step 521. In step 521, it is determined whether it is time to update position, e.g., it is determined if the sampling time interval (e.g., three seconds) has passed since the most recent determination of position of the user equipment. If not, then in step 523, other operations are performed for a while until control passes back to step 521. If it is determined in step 521 that it is time to update position, then control passes to step 525.

In step 525, the current position and speed of the user equipment is determined based on the current position and prior position of the positioning system co-located with the user equipment, e.g., UE 101.

In step 527, it is determined whether it is time to record current traffic condition (e.g., speed). For example, in some embodiments, traffic conditions recorded at least once per recording time, even if no trip line is encountered. In such embodiments, this is done as a contingency for trip line problems, such as for stopped traffic or for circumstances when trip lines are not yet defined or otherwise unavailable, or as backup for a trip line being in a hole in the positioning system coverage. If so, then in step 527 the current position and traffic conditions are recorded. Thus, the rich trip line client module 152 periodically computes its location and speed. When the client module 152 detects that it has missed some trip line encounters, it uses these samples as the information for the missing trip lines encounters. This technique essentially allows the client module 152 to “backfill” information for missed trip lines. In some embodiments, a recording time is not used; and step 527 and step 529 are omitted and control passes from step 525 to step 531.

In step 531, it is determined if the current position of the user equipment is outside the current bounding box B, such as the current tile. If so, then control passes back to step 503, described above, to request trip lines in the next bounding box B or tile. If not, control passes to 533 to determine if end conditions are satisfied. If so, then the client process ends. Otherwise, control passes back to step 511 and following to test the trip lines against the newly updated position of the user equipment.

If it is determined, in step 513, that the current position encounters the current candidate trip line, then the current candidate trip line becomes the last valid trip line (LVT), and control passes to step 541. In some embodiments, step 513 includes clearing the record formed in step 529 when it is determined that the current candidate trip line is the LVT.

In step 541, it is determined whether a trip line is missed. For example, it is determined whether the edge between the former and current LVT is not in the set E defined for graph G as described above. If so, then, in step 543, the skipped one or more trip lines are determined, e.g., by following edges in the set E from the current LVT to the former LVT. Thus the rich trip line client module 152 determines whether two trip lines, which indicate positions where values for a traffic condition are to be reported to a traffic service, are encountered in a different sequence than in an ordered plurality of trip lines received from the traffic service, e.g., from rich trip line service module 150.

The record of past positions and traffic conditions recorded in step 529 are examined to determine a traffic condition closest to the skipped trip line. For example, in some embodiments, the traffic condition for the skipped trip line is estimated by interpolating values of traffic conditions, in the records formed by repeated performance of step 529, to the position of the trip line. In some embodiments, the traffic condition for the skipped trip line is estimated by computing an average traffic condition value for records formed by repeated performance of step 529. A trip line record 380 is formed for each skipped trip line, with the skipped trip line ID in field 382 and the missed line alert field 388 holding data indicating a skipped trip line, and the estimated traffic condition in field 384. Control then passes to step 545.

Thus, taking advantage of ordered virtual trip lines to reduce network communication overhead, the rich trip line client module 152 sends traffic measurements in batches to the server. In an example embodiment, a single traffic measurement contains the following information: the trip line identifier in field 382, the speed when encountering this trip line in field 384, and a detection bit indicating whether the client was able to detect an encounter on this trip line in missed line alert field 388. For example, a traffic measurement 123000000, 40, 1 is a measurement for a trip line with identifier 123000000, a speed of 40 miles/hour measured at this trip line, and the client was able to compute its GPS position at this trip line. A traffic measurement 124000000, 20, 0 is a measurement for a trip line with identifier 124000000, a speed of 20 miles/hour measured near this trip line, and the client was not able to compute its GPS position at this trip line. In some embodiments that do not provide ordered trip lines within road segments, then steps 541 and 543 are omitted.

If it is determined in step 541 that a trip line is not missed, then control passes to step 545. In step 545, it is determined whether the value for the traffic condition (such as speed or acceleration) is normal or not at each trip line to be reported in the traffic message (including the LVT and any skipped trip lines). If not normal, then in step 547, a traffic alert is set, e.g., a value in the traffic alert field 386 is set to indicate an alert. Thus, trip lines received from the traffic service (e.g., service module 150) include normal values for the traffic condition; and the client module 152 determines whether the current value of the traffic condition at the encountered trip line is abnormal by comparing the current value to the normal value for the traffic condition at the trip line.

For example, in some embodiments, the rich trip line client module 152 finds which virtual trip line was encountered by checking the current position of the user equipment against the set of trip lines received from the rich trip line service module 150. The client module 152 also periodically collects speed samples in step 529. When the client module 152 detects a trip line encounter, the client module 152 then checks that the expected (“normal”) traffic statistic for that trip line “matches” the statistic for the samples that it has collected up to this point. If the client module 152 detects a significant deviation, the client module 152 sends this information to the service module 150 along with the speed. For example, the client module 152 may notify the server module 150 that conditions have changed if the average speed of the sample set it collected is 20% higher or lower than the expected speed at the trip line. After detecting a crossing and sending the speed data plus any available notification to the service module 150, the client module 152 clears its sample set and starts a new one. Thus, the rich trip line client module 152 sends data indicating the current value of the traffic condition, including data indicating an abnormal traffic condition alert at the encountered trip line, if it is determined that the current value of the traffic condition at the encountered trip line is abnormal.

In step 549, the traffic message is sent to the rich trip line service module 150 with trip line records 380 for the LVT and any skipped trip lines. Thus, if two trip lines are encountered in a different sequence, then the client module 152 sends, to the traffic service (e.g., service module 150), data indicating an undetected trip line between the two trip lines in the ordered plurality of trip lines. The trip line record 380 includes a measurement of the traffic condition at the trip line in field 384. Thus the client module 152 causes to be sent, to the traffic service (e.g., service module 150), data that indicates a current value of the traffic condition when the trip line is encountered.

The traffic message is used by the rich trip line service module 150 to update traffic data, determine whether to activate one or more de-activated trip lines and whether to move or remove any trip lines that might be in holes of the positioning system, as described above with reference to FIG. 4. For example, the service module 150 collects and aggregates speed and “GPS-quality” information on trip lines. The service module 150 uses the aggregated speed information as feedback for clients that issue requests to retrieve real-time traffic information. The service module 150 also maintains the GPS-quality information to determine which trip lines are not positioned properly or do not offer any information. A service module 150 may, for example, remove a trip line that always has its detection bit set to 0, or may reposition trip lines that have their detection bits set to 0 more than about 80% of the time. The upshot of this is that the usefulness of trip lines sent to clients is increased.

The use of ordered trip lines improves the current state of the art by facilitating the detection of data loss that occurs as a result of poor GPS reception. This information is useful to traffic-monitoring systems. A traffic monitoring system may use the information to re-organize the deployment of trip lines in areas with poor GPS coverage to address such problems. Also, the availability of such information means that “useless” trip lines are removed. Examples of useless trip lines are trip lines that cannot be detected, such as trip lines deployed in a commercial district where there are high-rise buildings all around. The use of ordered trip lines also facilitates the reconstruction of lost data. By regularly sampling the speed and location of the mobile client in step 529, holes in the data collection system can be filled. The ability to detect and recover from data loss means that the system 100 is able to generate more data than in current systems and provide better quality real time traffic information to users.

The use of ordered trip lines proposed herein also improves the performance of the rich trip line client module 152 by reducing the number of times the client module 152 needs the compute trip line encounters. In the previous implementation, a traffic client downloads a set of trip lines in a defined region, for example, the current map view on the mobile device. There may be thousands of trip lines in a single download. Periodically, the traffic client checks the set of all trip lines that it has downloaded until it finds it has encountered a trip line or the set is exhausted. Such an implementation is enhanced by removing an encountered trip line from the set as the user moves along a route. Even with such an enhancement, assuming the client downloaded 1000 trip lines and a trip line encounter is detected each sampling time, the traffic client would check 1000 trip lines, 999 trip lines, 998 trip lines and so on. Such computation can be expensive and can affect the responsiveness of the application as well as battery life of the mobile device running the application. By ordering the trip lines, the number of trip lines checked is limited. In the best case only the next trip line in order is checked, improving performance drastically and saving power. Ordered trip lines also reduce network communication cost overhead; and that means more power savings for mobile devices. In some embodiments, the combination of periodic sampling and ordered trip lines also allows the client module 152 to “project” the speed at trip lines later in the order and send all of this information in a single data transfer.

By developing a method that activates and deactivates virtual trip lines and keeping only the minimal representative set (MRS) deployed when traffic is following expected patterns, the system 100 creates a more efficient traffic data aggregation system since it reduces the amount of processing on the server side. The MRS also reduces the amount of data transferred between client and server. The system 100 also improves client application performance since the MRS reduces the computation cost in checking virtual trip line encounters. Furthermore, the system 100 provides better privacy protection for participating users since the MRS reduces the number of trip lines on a user's route (especially when there is a low density of vehicles on the user's route, then low vehicle density will typically mean that traffic will follow expected patterns). It is more difficult to track a user over a smaller number of trip line reports.

In some embodiments, the rich trip line fields are used separately and in some embodiments one or more are combined. For example, to find holes in the positioning system all trip lines are marked active and ordered. After holes are detected and trip lines moved, and sufficient statistics gathered to identify representative trip lines, then a subset of representative trip lines are kept active, while other trip lines are set to inactive, unless and until abnormal traffic conditions are detected.

The processes described herein for aggregating traffic information using rich trip lines may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to aggregate traffic information using rich trip lines as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of aggregating traffic information using rich trip lines.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to aggregate traffic information using rich trip lines. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for aggregating traffic information using rich trip lines. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for aggregating traffic information using rich trip lines, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for aggregating traffic information using rich trip lines with the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to aggregate traffic information using rich trip lines as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of services. Chip set or chip 700, or a portion thereof, constitutes a means for performing one or more steps of aggregating traffic information using rich trip lines.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to aggregate traffic information using rich trip lines. The memory 705 also stores the data associated with or generated by the execution of the inventive steps.

FIG. 8 is a diagram of exemplary components of a mobile terminal (e.g., handset) for communications, which is capable of operating in the system of FIG. 1, according to one embodiment. In some embodiments, mobile terminal 800, or a portion thereof, constitutes a means for performing one or more steps of aggregating traffic information using rich trip lines. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of aggregating traffic information using rich trip lines. The display 8 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to aggregate traffic information using rich trip lines. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
facilitating access, including granting access rights, to an interface to allow access to a service via a network, the service configured to, in response to receiving data indicating a current position, determine an ordered plurality of trip lines that indicate positions where a traffic condition is to be reported; and
returning data that indicates the ordered plurality of trip lines,
wherein the ordered plurality of trip lines are ordered such that a traveler encountering two trip lines of the plurality of trip lines in a different sequence indicates that a position near a third trip line was not detected by the traveler.

2. A method of claim 1, wherein the service is further configured to change a particular trip line in response to receiving data indicating that a position near the particular trip line was not detected.

3. A method of claim 1, wherein the service is further configured to receive data that indicates a traffic condition at a trip line of the ordered plurality of trip lines.

4. A method of claim 1, wherein,
the service is further configured to determine normal traffic conditions at each trip line of the ordered plurality of trip lines; and
returning data that indicates the ordered plurality of trip lines further comprises returning data that indicates normal traffic conditions for each of the ordered plurality of trip lines.

5. A method of claim 1, wherein:
the service is further configured to determine a subset of trip lines of a full plurality of trip lines in a vicinity of the current position;
traffic conditions at the subset of trip lines are representative of traffic conditions at the full plurality of trip lines; and
the ordered plurality of trip lines is an ordered set of the subset of trip lines.

6. A method of claim 5, wherein:
the service is further configured to determine whether a reported traffic condition at a trip line is substantively different from normal traffic conditions; and,
the ordered plurality of trip lines includes the full plurality of trip lines in the vicinity of the current position in response to the service receiving data that indicates the traffic condition at the trip line is substantively different from normal traffic conditions.

7. A method of claim 1, wherein the ordered plurality of trip lines is associated with a single road segment.

8. A method comprising:
determining whether two trip lines, which indicate positions where values for a traffic condition are to be reported to a traffic service, are encountered in a different sequence than in an ordered plurality of trip lines received from the traffic service; and
if the two trip lines are in a different sequence, then sending, to the traffic service, data indicating an undetected trip line between the two trip lines in the ordered plurality of trip lines.

9. A method of claim 8, further comprising:
determining when a trip line is encountered by comparing a current position of an apparatus to successive trip lines of the ordered plurality of trip lines starting after a last trip line most recently encountered until a trip line is determined to be within a threshold distance of the current position; and
causing to be sent, to the traffic service, data that indicates a current value of the traffic condition when the trip line is encountered.

10. A method of claim 9, wherein:
the ordered plurality of trip lines received from the traffic service includes normal values for the traffic condition; and,
the method further comprises determining whether the current value of the traffic condition at the encountered trip line is abnormal by comparing the current value to the normal value for the traffic condition at the trip line.

11. A method of claim 10, wherein sending data indicating the current value of the traffic condition further comprises sending, to the traffic service, data indicating an abnormal traffic condition alert at the encountered trip line, if it is determined that the current value of the traffic condition at the encountered trip line is abnormal.

12. An apparatus comprising:
at least one processor; and
at least one memory including computer program code,
the at least one memory and the computer program code configured to, with the at least one processor, cause the apparatus to perform at least the following,
in response to receiving data indicating a current position, determine an ordered plurality of trip lines that indicate positions where a traffic condition is to be reported; and
return data that indicates the ordered plurality of trip lines,
wherein the ordered plurality of trip lines are ordered such that a traveler encountering two trip lines of the plurality of trip lines in a different sequence indicates that a position near a third trip line was not detected by the traveler.

13. An apparatus of claim 12, wherein the apparatus is further caused, at least in part, to change a particular trip line in response to receiving data indicating that a position near the particular trip line was not detected.

14. An apparatus claim 12, wherein the apparatus is further caused, at least in part, to receive data that indicates a traffic condition at a trip line of the ordered plurality of trip lines.

15. An apparatus of claim 12, wherein,
the apparatus is further caused, at least in part, to determine normal traffic conditions at each trip line of the ordered plurality of trip lines; and
to return data that indicates the ordered plurality of trip lines further comprises to return data that indicates normal traffic conditions for each of the ordered plurality of trip lines.

16. An apparatus of claim 12, wherein:
the apparatus is further caused, at least in part, to determine a subset of trip lines of a full plurality of trip lines in a vicinity of the current position;
traffic conditions at the subset of trip lines are representative of traffic conditions at the full plurality of trip lines; and
the ordered plurality of trip lines is an ordered set of the subset of trip lines.

17. An apparatus of claim 16, wherein:
the apparatus is further caused, at least in part, to determine whether a reported traffic condition at a trip line is substantively different from normal traffic conditions; and,
the ordered plurality of trip lines includes the full plurality of trip lines in the vicinity of the current position in response to the service receiving data that indicates the reported traffic condition at the trip line is substantively different from normal traffic conditions.

18. An apparatus comprising:
at least one processor; and
at least one memory including computer program code,
the at least one memory and the computer program code configured to, with the at least one processor, cause the apparatus to perform at least the following,
determine based on data from a positioning system co-located with the apparatus whether two trip lines, which indicate positions where values for a traffic condition are to be reported to a traffic service, are encountered in a different sequence than in an ordered plurality of trip lines received from the traffic service; and
if the two trip lines are in a different sequence, then send, to the traffic service, data indicating an undetected trip line between the two trip lines in the ordered plurality of trip lines.

19. An apparatus of claim 18, the apparatus is further caused, at least in part, to:
determine when a trip line is encountered by comparing a current position of an apparatus to successive trip lines of the ordered plurality of trip lines starting after a last trip line most recently encountered until a trip line is determined to be within a threshold distance of the current position; and
causing to be sent, to the traffic service, data that indicates a current value of the traffic condition when the trip line is encountered.

20. An apparatus of claim 19, wherein:
the ordered plurality of trip lines received from the traffic service includes normal values for the traffic condition; and,
the apparatus is further caused, at least in part, to determine whether the current value of the traffic condition at the encountered trip line is abnormal by comparing the current value to the normal value for the traffic condition at the trip line.

21.-88. (canceled)
